(19) United States
(12) Patent Application Publication
(10) Pub. No.: US 2021/0095397 A1
(43) Pub. Date: Apr. 1, 2021

(54) HYBRID FABRICS OF HIGH PERFORMANCE POLYETHYLENE FIBER

(71) Applicant: DSM IP ASSETS B.V., Heerlen (NL)

(72) Inventors: Marc KANTERS, Echt (NL); Ulrich HEISSERER, Echt (NL); Johannes Petrus Marinus PLUG, Echt (NL); Timothy James KIDD, Echt (NL); Jan STOLK, Echt (NL)

(21) Appl. No.: 16/954,815

(22) PCT Filed: Oct. 12, 2018
(86) PCT No.: PCT/EP2018/077848

§ 371 Date: Jun. 17, 2020

(30) Foreign Application Priority Data
Dec. 21, 2017 (EP) 17209409.6

(51) Int. Cl. D01F 6/46; D01D 5/08; D03D 15/573; D03D 11/00

(52) U.S. Cl. CPC D01F 6/46; D01D 5/08; D03D 15/573; D03D 11/00; D10B 2101/12; D10B 2501/04; D10B 2507/04; D10B 2101/06; D10B 2321/0211

(57) ABSTRACT

The invention relates to hybrid fabric comprising: a high-performance polyethylene (HPPE) fiber having a tensile modulus of at least 110 GPa, preferably higher than 135 GPa, as measured according to ASTM D885M-2014; and a non-polymeric fiber, wherein the cross-sectional area of the HPPE fiber is equal to or smaller than the cross-sectional area of the non-polymeric fiber, the cross-sectional area being defined as the linear density of the fiber divided by volumetric density of the fiber. The invention also relates to a composite comprising the hybrid fabric and to an article comprising the composite.

The present invention relates to a hybrid fabric comprising a high-performance polyethylene fiber (HPPE) and a non-polymeric fiber. The invention also relates to a composite comprising at least one hybrid fabric. Furthermore, the invention directs to the use of the hybrid fabric in various applications.

Composite materials comprising non-polymeric fibers, such as continuous hard fibers, like carbon fibers, glass fibers, basalt fibers, silicon carbide fibers or boron fibers, typically in a cured polymer matrix are well known in the art as being excellent structural materials. Of these, glass fibers and carbon fibers are mostly used. These materials are known to be light, strong, and stiff and therefore are increasingly applied in high performance structures, e.g. air planes, rockets, bridges, cars, bicycles, and various sporting goods, in fact they are applied in all applications where structural performance is important. However, these materials have at least one disadvantage, i.e. their impact resistance is very low or, in other words, their sensitivity to impact damage is very high.

It is also known in the art that this very high sensitivity to impact damage can be reduced by replacing part of these hard fibers by very strong polymeric fibers, such as high-performance polyethylene (HPPE) fibers, this replacement considerably increasing the impact resistance of the composites. For instance, gel-spun ultrahigh molecular weight polyethylene (UHMWPE) fibers are known to be a very attractive option for this requirement. However, such strong polymeric fibers typically show only high strength under tensile loading, whereas other strength properties, like axial compression strength, are very low. Moreover, the adhesion of matrix materials to these polymeric fibers is known to be poor. Thus, the improvement of the impact resistance is penalized with a reduction in structural properties, like tensile strength and modulus. So, the replacement of the hard fibers by very strong polymeric fibers is currently mainly attractive for applications where impact resistance is dominant, while other structural properties may be sacrificed to a considerable extent. For instance, the problem of increasing impact resistance, at a penalty of decreasing structural performance is extensively discussed in literature, e.g. in Dyneema fibers in composites, the addition of special mechanical functionalities by R. Marissen, L. Smit, C. Snijder, in Advancing with composites 2005, Naples, Italy, Oct. 11-14, 2005, but no real solution is provided therein. This document particularly discloses epoxy resin reinforced with glass fiber fabrics and combined with Dyneema®/glass hybrid fabrics containing 57% by volume of Dyneema® and analyses these composites for safety, vibration damping or penetration resistance.

The prior art also provides some options for improving structural performance of composites at good impact resistance, e.g. to improve the adhesion of the HPPE, i.e. UHMWPE fibers to the composite matrix material by applying corona or plasma treatment to the fibers, or by applying certain primers or sizing, or by strong oxidizing treatments of the fibers, e.g. with permanganates. Many examples of such treatments exist, varying in intensity and plasma composition. All such treatments have in common that they cause a reduction of the fiber strength, thus a reduction of the composite performance, e.g. of impact resistance and strength decrease requires, or requires an extra processing step and thus increase manufacturing costs. Moreover, these treatments lose effectivity after long storage time, meaning that manufacturing of such composite should be carried out within only few weeks after the fiber treatment, which is not always possible.

It is the aim of the present invention to therefore provide a hybrid fabric that at least partly overcomes the above-mentioned problems. In particular, it is an aim of the present invention to provide a hybrid fabric resulting in improved structural properties of a composite, e.g. improved tensile strength and modulus, while maintaining high impact resistance properties, and thus enabling more and various application opportunities, reducing the need of fabric pretreatment, and when applied in a composite having the same areal density (weight) compared to the composites known in the prior art, allowing use of more layers in a composite for the same areal density.

This objective was achieved according to the present invention by a hybrid fabric comprising: i) a high-performance polyethylene (HPPE) fiber having a tensile modulus of at least 110 GPa, as measured according to ASTM D885M-2014; and ii) a non-polymeric fiber, wherein the cross-sectional area of the HPPE fiber is equal to or smaller than the cross-sectional area of the non-polymeric fiber, the cross-sectional area of the fiber being defined as the linear density of the fiber divided by the volumetric density of the fiber.

Preferably, the hybrid fabric comprises: i) a high-performance polyethylene (HPPE) fiber having a tensile modulus of higher than 135 GPa, as measured according to ASTM D885M-2014; and ii) a non-polymeric fiber, wherein the cross-sectional area of the HPPE fiber is equal to or smaller than the cross-sectional area of the non-polymeric fiber, the cross-sectional area of the fiber being defined as the linear density of the fiber divided by the volumetric density of the fiber. More preferably, the hybrid fabric comprises: i) a high-performance polyethylene (HPPE) fiber arranged in a yarn, having a tensile modulus of higher than 135 GPa, preferably of at least 140 GPa, as measured according to ASTM D885M-2014; and ii) a non-polymeric fiber arranged in a yarn, wherein the cross-sectional area of the HPPE fiber is equal to or smaller than the cross-sectional area of the non-polymeric fiber, the cross-sectional area of the fiber being defined as the linear density of the fiber divided by the volumetric density of the fiber.

Most preferably, the hybrid fabric according to the invention comprises: i) a high-performance polyethylene (HPPE) fiber arranged in a yarn, having a tensile modulus of at least 110 GPa, preferably of at least 120 GPa, more preferably of at least 130 GPa and most preferably of at least 135 GPa, and yet most preferably higher than 135 GPa, as measured according to ASTM D885M-2014; and ii) a non-polymeric fiber arranged in a yarn, wherein the cross-sectional area of the HPPE yarn is equal to or smaller than the cross-sectional area of the non-polymeric yarn, the cross-sectional area of the yarn being defined as the linear density of the yarn divided by the volumetric density of the fiber.

It has unexpectedly been found that the hybrid fabric according to the present invention shows improved structural properties when applied in a composite, e.g. it shows improved tensile strength and modulus, while maintaining high impact resistance properties, and thus enabling more and various application opportunities, without the need of fabric pretreatment and when applied in a composite having the same areal density (weight) compared to the composites known in the prior art, allowing use of more layers in a composite for the same areal density. Preferably, the composite obtained by applying the hybrid fabric shows the following properties: improved tensile modulus of at least 42 GPa, more preferably of at least 46 GPa; improved tensile strength of at least 475 MPa, preferably of at least 518 MPa; and high impact properties, i.e. Fmax of at least 2740 N, preferably of at least 3150 MPa, Energy to Fmax of at least 4.80 J, preferably of at least 6.40 J and puncture energy of at least 13.5 J, preferably of at least 17.25 J, all properties being measured by applying the methods described in the Examples herein below.

By term “composite” is herein understood a material comprising fibers and a material in a different form, such as a matrix material, e.g. a co(polymer) resin impregnated through the fibers and/or coated on the fibers. The matrix material is typically a liquid (co)polymer resin impregnated in between the fibers and optionally subsequently hardened. Hardening or curing may be done by any means known in the art, e.g. a chemical reaction, or by solidifying from molten to solid state. Suitable examples include thermoplastic resins, epoxy resins, polyester or vinylester resins, or phenolic resins.

By term “hybrid material”, in particular hybrid fabric, is herein understood a material, i.e. a fabric comprising at least two different kind of fibers, i.e. the fibers have different chemical structure and properties. When used in a composite, a hybrid fabric with the at least two different kind of fibers being mixed in the same fabric layer is commonly known in the art and herein referred to as intraply hybrid layer. Within the context of the present invention, a “yarn” is a monofilament yarn, which may be a tape or a multifilament yarn, which is herein an elongated body comprising a plurality of, i.e. at least 2, fibers. In other words, a “yarn” is herein understood an elongated body, which may be a monofilament being a fiber or a tape, or a multifilament yarn that comprises a plurality of fibers, i.e. at least 2 fibers. Herein “fibers” are understood to be elongated bodies with length dimension much greater than their transversal dimensions, e.g. width and thickness. The term fiber includes a monofilament, a ribbon, a strip or a tape and the like, and can have a regular or an irregular cross-section. The fibers may have continuous lengths, known in the art as filaments, or discontinuous lengths, known in the art as staple fibers. A tape for the purposes of the present invention may have a cross-sectional aspect ratio of at least 5:1, more preferably at least 20:1, even more preferably at least 100:1 and yet even more preferably at least 1000:1. The width of the tape may be between 1 mm and 200 mm, preferably between 1.5 mm and 50 mm, and more preferably between 2 mm and 20 mm. Thickness of the flat tape preferably is between 10 μm and 200 μm and more preferably between 15 μm and 100 μm.

The hybrid fabric according to the present invention may be of any construction known in the art, e.g. woven, knitted, plaited, braided or a combination thereof. Knitted fabrics may be weft knitted, e.g. single- or double-jersey fabric or warp knitted. Further examples of woven and knitted fabrics as well as the manufacturing methods thereof are described in “Handbook of Technical Textiles”, ISBN 978-1-59124-651-0 at chapters 4, 5 and 6, the disclosure thereof being incorporated herein as reference. A description and examples of braided fabrics are described in the same Handbook at Chapter 11, more in particular in paragraph 11.4.1, the disclosure thereof being incorporated herein by reference. The areal density of fabrics is preferably between 10 and 2000 g/m², more preferably between 50 and 1000 g/m² or between 100 and 1000 g/m² or between 150 and 500 g/m² or between 100 and 500 g/m². Preferably, a woven fabric is used in the hybrid fabric according to the present invention.

By “warp yarn” is generally understood the yarns that run substantially lengthwise, i.e. in the machine length direction of the fabric. In general, the length direction is only limited by the length of the warp yarns whereas the width is mainly limited by the number of individual warp yarns and the width of the weaving machine employed. The hybrid fabric according of the invention may be a woven fabric that may have multiple warp yarns with similar or different composition. By term “weft yarn” is generally understood the yarns that run in a cross-wise direction, i.e. transverse to the machine direction of the fabric. Defined by a weaving sequence of the product, the weft yarn repeatedly interlaces or interconnects with at least one warp yarn. The angle formed between the warp yarns and the weft yarns can vary from 15 to 90, for instance be about 90°, 60°, 45° or 30°.

A fabric is typically known in the art to be a three-dimensional (3D) object, wherein one dimension (the thickness) is much smaller than the two other dimensions (the length or the warp direction and the width or weft direction). In general, the length direction is only limited by the length of the warp yarns whereas the width of a fabric is mainly limited by the count of individual warp yarns and the width of the weaving machine employed. The position of the warp yarns is defined according to their position across the thickness of the fabric, whereby the thickness is delimited by an outside and an inside surface. By ‘outside’ and ‘inside’ is herein understood that the fabric comprises two surfaces that may be distinguishable. The terminology ‘outside’ and ‘inside’ should not be interpreted as a limiting feature rather than a distinction made between the two different surfaces. It may as well be that for specific uses the surfaces will be facing the opposite way or that the fabric is folded to form a double layer fabric with two identical surfaces exposed on either side while the other surfaces are turned towards each other.

A weave structure is typically characterized in the prior art by a float, a length of the float and a float ratio. The float is a portion of a weft yarn delimited by two consecutive points where the weft yarn crosses the virtual plane formed by the warp yarns. The length of the float expresses the number of warp yarns that the float passes between said two delimiting points. Typical lengths of floats may be up to 11, 11 lengths of floats indicating that the weft yarn passes 11 warp yarns before crossing the virtual plane formed by the warp yarns by passing between adjacent warp yarns. The float ratio is the proportion between the lengths of the floats of the weft yarn on either side of the plane formed by the warp yarns. The weave structure for the inside layer may be chosen independent form the outside layer.

The hybrid fabric according to the invention is preferably a woven fabric that typically comprises one single weft yarn or multiple weft yarns, that may have similar or different composition. The weave structure typically formed by the warp yarns and the weft yarns in a woven fabric can be of multiple types, as known in the art, depending upon the number and diameters of the employed warp yarns and weft yarns as well as on the weaving sequence used between the warp yarns and the weft yarns during the weaving process. Such different sequences are well known to the person skilled in the art. Through the weaving process, the weft yarn typically interweaves the warp yarns, hereby partially interconnecting the outside and inside layers comprising respectively said warp yarns. Such interweaved structure may also be called a monolayer fabric even though such monolayer may be composed of sub-layers as described above. Weaving of tapes is also known per se, for instance from document WO2006/075961, which discloses a method for producing a woven layer from tape-like warps and wefts comprising the steps of feeding tape-like warps to aid shed formation and fabric take-up; inserting tape-like weft in the shed formed by said warps; depositing the inserted tape-like weft at the fabric-fell; and taking-up the produced woven monolayer; wherein said step of inserting the tape-like weft involves gripping a weft tape in an essentially flat condition by means of clamping, and pulling it through the shed. When weaving tapes specially designed weaving elements are commonly used. Particularly, suitable weaving elements are described in U.S. Pat. No. 6,450,208.

In the context of the present invention, the cross-sectional area refers to the cross-sectional area of the unit structure (e.g. of weaving or of the weave) that forms the hybrid fabric. For instance, if the unit structure is a multifilament yarn, then the cross-sectional area refers to the cross-sectional area of the multifilament yarn; or if the unit structure is a monofilament yarn, such as a fiber or a tape, then the cross-sectional area refers to the cross-sectional area of the monofilament yarn. The cross-sectional area of the unit structure, such as the fiber or the yarn is defined herein as the linear density of the unit structure, such as the fiber or the yarn (tex, which is weight per unit length), divided by the volumetric density of the unit structure, such as the fiber or the yarn (in SI units being thus (kg/m)/(kg/m³)=m²). The value of the volumetric density of the yarn may be the same as the value of the volumetric density of the fiber.

Preferably, the hybrid fabric according to the present invention is a woven fabric and typically contains weft yarns and warp yarns. Most preferably, the hybrid fabric contains weft yarns and warp yarns, with the cross-sectional area of the unit yarn (i.e. the yarn in warp direction and weft direction) containing the HPPE fiber being equal to or smaller than the cross-sectional area of the unit yarn containing non-polymeric fibers.

In the context of the present invention, a HPPE fiber is understood to be a polyethylene fiber with improved mechanical properties such as tensile strength, tensile modulus, abrasion resistance, cut resistance and/or the like. Preferably, high performance polyethylene fiber comprises or consists of polyethylene fiber with a tensile strength of at least 1.5 N/tex, preferably at least 2 N/tex, more preferably at least 2.5 N/tex and more preferably of at least 3.5 N/tex, on yarn level, measured according to the method in the Example section of this patent application. Preferred polyethylene is high molecular weight (HMWPE) or ultrahigh molecular weight polyethylene (UHMWPE). Best results were obtained when the high-performance polyethylene fiber comprise ultra-high molecular weight polyethylene (UHMWPE) and have a tenacity of at least 3.0 N/tex, more preferably of at least 3.5 N/tex, measured at yarn level.

The HPPE fiber used in the hybrid fabric according to the present invention has a tensile modulus preferably of at least 110 GPa; yet preferably of at least 120 GPa; more preferably of at least 130 GPa; most preferably of at least 135 GPa; yet most preferably of at least 140 GPa; yet most preferably of at least 145 GPa; yet most preferably of at least 150 GPa; yet most preferably of at least 155 GPa; 160 GPa; 165 GPa; 170 GPa; 180 GPa or of at least 190 GPa or even of at least 200 GPa, as measured according to ASTM D885M-2014, as also described in the Examples section of present invention. There is no limitation to an upper limit of tensile modulus of the HPPE fiber, as this may be dependent on the application of the fiber and any practicalities. The tensile modulus can be lower than 500 GPa; or lower than 400 GPa; or lower than 300 GPa; or it may be lower than 220 GPa.

Preferably, the hybrid fabric of the present invention comprises a HPPE fiber comprising high molecular weight polyethylene (HMWPE) or ultra-high molecular weight polyethylene (UHMWPE) or a combination thereof, preferably the HPPE fibers substantially consist of HMWPE and/or UHMWPE. The inventors observed that for HMWPE and UHMWPE the best composite performance could be achieved.

For practical reasons, the titer of the HPPE fiber, preferably of the HPPE yarn, that can be a monofilament or multifilament yarn, can be at least 100 dtex and most 50000 dtex, preferably at most 20000 dtex, more preferably at most 10000 dtex, most preferably at most 5000 dtex. Preferably, the titer of the HPPE fiber, preferably of the yarn, is in the range of 100 to 10000 dtex, more preferably 500 to 6000 dtex, yet more preferably of from 1000 to 6000 dtex and most preferably in the range from 1000 to 3000 dtex, yet most preferably in the range of 500 to 3000 dtex yet most preferably in the range of from 220 to 1300 dtex. The titer of the HPPE fiber, preferably of the HPPE yarn is preferably at most 1200 dtex.

In the context of the present invention, the expression ‘substantially consisting of’ has the meaning of ‘may comprise a minor amount of further species’ wherein minor is up to 5 wt %, preferably of up to 2 wt % of said further species or in other words ‘comprising more than 95 wt % of’ preferably ‘comprising more than 98 wt % of’ HMWPE and/or UHMWPE.

In the context of the present invention, the polyethylene (PE) may be linear or branched, whereby linear polyethylene is preferred. Linear polyethylene is herein understood to mean polyethylene with less than 1 side chain per 100 carbon atoms, and preferably with less than 1 side chain per 300 carbon atoms; a side chain or branch generally containing at least 10 carbon atoms. Side chains may suitably be measured by FTIR. The linear polyethylene may further contain up to 5 mol % of one or more other alkenes that are copolymerisable therewith, such as propene, 1-butene, 1-pentene, 4-methylpentene, 1-hexene and/or 1-octene.

The PE is preferably of high molecular weight with an intrinsic viscosity (IV) of at least 2 dl/g; more preferably of at least 4 dl/g, most preferably of at least 8 dl/g. Such polyethylene with IV exceeding 4 dl/g are also referred to as ultra-high molecular weight polyethylene (UHMWPE). Intrinsic viscosity is a measure for molecular weight that can more easily be determined than actual molar mass parameters like number and weigh average molecular weights (Mn and Mw).

The HPPE fiber used according to the present invention may be obtained by various processes, for example by a melt spinning process, a gel spinning process or a solid-state powder compaction process.

A method for the production of the HPPE fiber may be a solid-state powder process comprising the feeding the polyethylene as a powder between a combination of endless belts, compression-molding the polymeric powder at a temperature below the melting point thereof and rolling the resultant compression-molded polymer followed by solid state drawing. Such a method is for instance described in U.S. Pat. No. 5,091,133, which is incorporated herein by reference. If desired, prior to feeding and compression-molding the polymer powder, the polymer powder may be mixed with a suitable liquid compound having a boiling point higher than the melting point of said polymer. Compression molding may also be carried out by temporarily retaining the polymer powder between the endless belts while conveying them. This may for instance be done by providing pressing platens and/or rollers in connection with the endless belts.

Another method for the production of the HPPE fiber used in the invention may comprise feeding the polyethylene to an extruder, extruding a molded article at a temperature above the melting point thereof and drawing the extruded fibers below its melting temperature. If desired, prior to feeding the polymer to the extruder, the polymer may be mixed with a suitable liquid compound, for instance to form a gel, such as is preferably the case when using ultra high molecular weight polyethylene. In yet another method, the HPPE fiber used in the invention may be prepared by a gel spinning process. A suitable gel spinning process is described in for example GB-A-2042414, GB-A-2051667, EP 0205960 A and WO 01/73173 A1. In short, the gel spinning process comprises preparing a solution of a polyethylene of high intrinsic viscosity, extruding the solution into a solution-fiber at a temperature above the dissolving temperature, cooling down the solution-fiber below the gelling temperature, thereby at least partly gelling the polyethylene of the fiber, and drawing the fiber before, during and/or after at least partial removal of the solvent.

In the described methods to prepare HPPE fiber drawing, preferably uniaxial drawing, of the produced fibers may be carried out by means known in the art. Such means comprise extrusion stretching and tensile stretching on suitable drawing units. To attain increased mechanical tensile strength and stiffness, drawing may be carried out in multiple steps.

In case of the preferred UHMWPE fiber, drawing is typically carried out uniaxially in a number of drawing steps. The first drawing step may for instance comprise drawing to a stretch factor (also called draw ratio) of at least 1.5, preferably at least 3.0. Multiple drawing may typically result in a stretch factor of up to 9 for drawing temperatures up to 120° C., a stretch factor of up to 25 for drawing temperatures up to 140° C., and a stretch factor of 50 or above for drawing temperatures up to and above 150° C. By multiple drawing at increasing temperatures, stretch factors of about 50 and more may be reached. This results in HPPE fibers, whereby for ultrahigh molecular weight polyethylene, tensile strengths of 1.5 N/tex to 3.5 N/tex and more may be obtained.

By “non-polymeric fiber” is herein understood a fiber that does not contain a polymer, i.e. a polymer-free fiber. Alternative definition of non-polymeric fiber used in the present invention is a fiber essentially free of hydrogen atoms, i.e. a fiber that contains hydrogen atoms in an amount of at most 1 mass %, relative to the total mass of the fiber. Suitable examples of the non-polymeric fiber according to the present invention is basalt fiber, wollastonite fiber, glass fiber and and/or carbon fiber. Preferably the non-polymeric fiber is a yarn. All these non-polymeric fibers, their structure and properties, are known to the skilled person in the art. The non-polymeric fibers may be hard fibers having a Moh's hardness of higher than 2.5; 3; 4; 5 or even higher than 6.

The non-polymeric fiber, preferably the yarn comprising the non-polymeric fiber, may have a titer of from 100 dtex to 100000 dtex, preferably of from 100 dtex to 50000 dtex. In particular, a carbon fiber or basalt or glass fiber, preferably yarns comprising carbon, basalt or glass fibers, may have a titer of between 500 and 40000 dtex, in particular between 650 and 32000 dtex and may have a filament count of between 1000 and 48000. Mixtures of a glass fiber, a carbon fiber, a wollastonite fiber and/or a basalt fiber, preferably arranged in a yarn, may also be used in any ratio according to the present invention. Preferably, the non-polymeric fiber used according to the present invention is a fiber selected from a group consisting of a carbon fibers, a glass fiber, a basalt fiber and/or mixtures thereof, more preferably the non-polymeric fiber used according to the present invention is selected from a group consisting of a carbon fiber and a glass fiber.

The volumetric density of the non-polymeric fiber may be of from 1.1 to 3 g/cm³, preferably of from 1.5 to 2.6 g/cm³.

The hybrid fabric according to the present invention may further contain a polymeric resin that may be coated (or impregnated) on the HPPE fiber (that may be in addition to the matrix material, when present), the polymeric resin can be as described for instance in documents WO2017060461 and WO2017060469. The polymeric resin may be present in an amount of 0.15 to 30 vol % relative to the total volume of the hybrid fabric and may be selected from a group consisting of a homopolymer of ethylene, a homopolymer of propylene, a copolymer of ethylene, a copolymer of propylene. It may comprise the various forms of polyethylene, ethylene-propylene co-polymers, other ethylene copolymers with co-monomers such as 1-butene, isobutylene, as well as with hetero atom containing monomers such as acrylic acid, methacrylic acid, vinyl acetate, maleic anhydride, ethyl acrylate, methyl acrylate; generally, α-olefin and cyclic olefin homopolymers and copolymers, or blends thereof. Preferably, the polymeric resin is a copolymer of ethylene or propylene which may contain as co-monomers one or more olefins having 2 to 12 C-atoms, in particular ethylene, propylene, isobutene, 1-butene, 1-hexene, 4-methyl-1-pentene, 1-octene, acrylic acid, methacrylic acid and vinyl acetate. In the absence of co-monomer in the polymeric resin, a wide variety of polyethylene or polypropylene may be used amongst which high density polyethylene (HDPE), linear low density polyethylene (LLDPE), very low density polyethylene (VLDPE), low density polyethylene (LDPE), isotactic polypropylene, atactic polypropylene, syndiotactic polypropylene or blends thereof. Furthermore, preferably the polymeric resin may be a functionalized polyethylene or polypropylene or copolymers thereof or alternatively the polymeric resin may comprise a functionalized polymer. Such functionalized polymers are often referred to as functional copolymers or grafted polymers, whereby the grafting refers to the chemical modification of the polymer backbone mainly with ethylenically unsaturated monomers comprising heteroatoms and whereas functional copolymers refer to the copolymerization of ethylene or propylene with ethylenically unsaturated monomers. Preferably, the ethylenically unsaturated monomer comprises oxygen and/or nitrogen atoms. Most preferably, the ethylenically unsaturated monomer comprises a carboxylic acid group or derivatives thereof resulting in an acylated polymer, specifically in an acetylated polyethylene or polypropylene. Preferably, the carboxylic reactants are selected from the group consisting of acrylic, methacrylic, cinnamic, crotonic, and maleic, amine, fumaric, and itaconic reactants. Said functionalized polymers typically comprise between 1 and 10 wt % of carboxylic reactant or more. The presence of such functionalization in the resin may substantially enhance the dispersability of the resin and/or allow a reduction of further additives present for that purpose such as surfactants. Preferably, ethylene acrylic acid (EAA) copolymer, such as the commercially available EAA copolymers sold under the tradename Michemprime®, is the polymeric resin used as this copolymer enhances adhesion to HPPE fiber and non-polymeric materials. The polymeric resin may have a density as measured according to ISO1183-2004 in the range from 860 to 970 kg/m³, preferably from 870 to 930 kg/m³, yet preferably from 870 to 920 kg/m³, more preferably from 875 to 910 kg/m³. The polymeric resin may be a semi-crystalline polyolefin and has a peak melting temperature in the range from 40 to 140° C. and a heat of fusion of at least 5 J/g, measured in accordance with ASTM E793 and ASTM E794, considering the second heating curve at a heating rate of 10 K/min, on a dry sample.

Preferably, the amount of HPPE fiber on volume basis is equal to or lower than the amount of non-polymeric fiber in the hybrid fabric according to the invention. More preferably, the volume ratio of the HPPE fiber to the non-polymeric fiber is about 1:5 to 1:1 or in the range of 1:5 to 1:2 in the hybrid fabric according to the present invention.

The HPPE fiber, preferably the HPPE yarn may be used in weft and/or in warp directions in the hybrid fabric according to the present invention. Such construction shows better structural properties. Other constructions of the fabric may include the non-polymeric fiber, preferably being selected from the group consisting of a basalt fiber, a glass fiber and a carbon fiber and/or mixtures thereof in warp direction and a HPPE fiber only in weft direction or a non-polymeric fiber, preferably being selected from the group consisting of a basalt fiber, a glass fiber and a carbon fiber and/or mixtures thereof and a HPPE fiber in warp direction and a only HPPE fiber in weft direction.

The hybrid fabric according to the present invention may further also comprise a matrix material. Typically, a (hybrid) fabric containing a matrix material may also be referred to in the art and herein as “prepreg”, and a (hybrid) fabric free of a matrix material may be also referred in the art and herein to as a ‘dry (hybrid) fabric’. Any matrix material, e.g. relative to thermoplastic or on thermoset polymers known to the skilled person in the art of composites can be used. Preferred examples of the matrix material include a resin, preferably an epoxy resin, a polyurethane resin, a vinylester resin, a phenolic resin, a polyester resin and/or mixtures thereof. The total concentration of the matrix material may be from 80 to 30 vol %, preferably from 70 to 40 vol %, yet preferably from 60 to 40 vol %, relative to the total volume of the hybrid fabric (prepreg). Higher amount of matrix material adds disadvantageously to the total weight of the hybrid fabric. Some voids may be present in the hybrid fabric. Preferably, no voids are present in the hybrid fabric according to the present invention. Any curing agent known in the art may be added to the matrix material, in any conventional amounts, by using any known method. The matrix material may further comprise at least one additives known in the art, in any conventional amounts, such as various fillers, dyes, pigments, e.g. white pigment, flame-retardants, stabilizers, e.g. ultraviolet (UV) stabilizers, colorants. As commonly practiced in the art, such additives can be used to overcome common deficiencies of the fabric. The additives can be applied by any method already known in the art. The skilled person can readily select any suitable combination of additives and additive amounts without undue experimentation. The amount of additives depends on their type and function. Typically, their amounts are from 0 to 30 vol %, based on the total volume of the matrix material.

Preferably, the hybrid fabric comprises or consists of from 15 to 50 vol % of the HPPE fiber, preferably at most 35 vol % HPPE fiber, and from 50 to 85 vol % non-polymeric fiber, relative to the total volume of the hybrid fabric. Higher amounts of the HPPE fiber result in lower values for mechanical properties. Lower amounts of the HPPE fiber result in lower impact strength properties and decrease of penetration resistance (i.e. out-of-plane impact resistance). More preferably, the hybrid fabric comprises or consists of from 15 to 50 vol % of the HPPE fiber, preferably of at most 45 vol %; or of at most 40 vol % or of at most 35 vol % HPPE fiber, more preferably of from 15 to 35 vol % of the HPPE fiber, relative to the total volume of the hybrid fabric. Higher amounts of the HPPE fiber result in lower values for mechanical properties. Lower amounts of the HPPE fiber result in lower impact strength properties and decrease of penetration resistance (i.e. out-of-plane impact resistance). The hybrid fabric preferably comprises of from 50 to 85 vol % non-polymeric fiber, preferably when arranged in a yarn, relative to the total volume of the hybrid fabric. These amounts for HPPE fibers and non-polymeric fibers are preferably relative to the total volume of the matrix free fabric.

The present invention also relates to a composite (or to a hybrid composite as may also be referred to herein) comprising at least one hybrid fabric according to the present invention, that is preferably positioned as at least one layer of fabric. The composite may contain at least two hybrid fabrics, or at least three hybrid fabrics according to the present invention. The composite may further comprise other types of fabrics, i.e. with a different construction and composition than the hybrid fabric according to the present invention (for instance, a layer of fabric comprising or consisting of non-polymeric materials, such as carbon fibers or glass fibers) or it may consist of at least one layer, preferably of at least two layers, more preferably at least 4 of the hybrid fabrics according to the invention that may be arranged at any location in the composite stack, for instance as layers on the upper surface and/or lower surface and/or as inside layer(s) in the composite There is no limitation to a maximum number of fabrics in the composite as this may be dependent on the application of the composite and any practicalities. The composition of the fabrics in the composite may be the same or different. The fabrics are preferably stacked in the composite such that they overlap over substantially their whole surface area, e.g. more than 80% of their total area.

The composite according to the invention contains preferably a stack of fabrics, that may also be referred herein to as a stack of layers of fabrics, the stack having an upper-stack surface area and a lower-stack surface area opposite to the upper-stack surface area. With respect to its location towards the upper-stack surface area and/or towards another layer, each layer of the composite that also comprises the hybrid fabric of the invention typically has an upper surface area (herein may also be referred to as “upper side”) and a lower surface area (herein may also be referred to as “lower side” or “back surface”) opposite to the upper surface. It goes without saying that although called “upper” and “lower”, these denominations are not limiting, and they may be interchangeable.

The composite of the invention may contain at least 1 layer of fabric A and at least 1 layer of fabric B, with fabric A comprising of from 100 to 80 vol % of non-polymeric fibers, based on the total volume of the fabric A, and from 0 to 20 vol % HPPE fibers, and preferably consisting of non-polymeric fibers; and with fabric B being the hybrid fabric according to the present invention, wherein said fabrics are preferably stacked such that they overlap over substantially their whole surface area. The concentration (vol %) of the HPPE fibers in the hybrid fabric (B) according to the present invention is preferably higher than the concentration (vol %) of the HPPE fibers in the adjacent fabric A layer(s).

The hybrid fabric according to the present invention is preferably symmetrical, meaning that the hybrid fabric comprises substantially the same amount of HPPE yarns and substantially the same amount of non-polymeric yarns on each side of the hybrid fabric, i.e. on surface area and on the opposite surface area of the hybrid fabric. In this context, “substantially the same amount” means that the vol % of HPPE yarns on one surface area of the hybrid fabric deviates less than 10% from the vol % of HPPE yarns on the opposite surface area of the hybrid fabric, based on the total volume of yarns in the (dry) hybrid fabric. The absolute amount of HPPE yarns on both sides depends on the hybridization ratio of polymeric and non-polymeric fibers. This construction results in little or no delamination of the composite where the hybrid fabric according to the present invention is used.

Preferably, hybrid composite comprises a total of from 40 to 70 vol. % fibers (HPPE fibers and non-polymeric fibers), preferably arranged in yarns and from 30 to 60 vol % of a matrix material, each vol %. being based on the total volume of the hybrid composite. The matrix material present in the final composite may be the matrix material added to the dry hybrid fabric(s) layers to form prepregs, or may be added to the stack of dry hybrid fabric layers to form the composite by e.g. infusion. More preferably, the hybrid composite according to the present invention comprises or consists of:
i) from 5 to 35 vol. % of the HPPE fiber, preferably arranged in a yarn, relative to the total volume of the hybrid composite, with the HPPE fibers having a tensile modulus of at least 110 GPa, preferably of at least 120 GPa, more preferably of at least 130 GPa and most preferably of at least 135 GPa, and yet most preferably higher than 135 GPa, measured according to ASTM D885M-2014;
ii) from 20 to 60 vol % of the non-polymeric fiber, preferably arranged in a yarn, relative to the total volume of hybrid composite, and
iii) from 60 to 25 vol % of a matrix material, relative to the total volume of the hybrid composite, wherein the cross-sectional area of the HPPE fiber, preferably of the HPPE yarn is equal to or smaller than the cross-sectional area of the non-polymeric fiber, preferably of the non-polymeric yarn.

The total sum of volumes of i) and ii) and iii) components and optionally, of volumes of conventional additives if present, should not exceed 100%.

The length (L) and the width (W) of the composite according to the invention may widely vary, depending on the field where the composite is applied, e.g. the L and/or W may be in the centimeter range for small products like toys, household products or machine components, or meter range e.g. for cars and bicycles, to even 10 or 100 of meters for aircrafts rockers ships or bridges. The thickness of the composite of the invention can vary within wide ranges and is dictated by e.g. the number of fabrics comprised and/or by the processing conditions, e.g. pressure and time.

The composite according to the present invention can be made with any process known in the art. Suitable examples of known such processes preferably using either dry fabrics or prepregs, include pre-impregnated fabrics process, hand lay-up, resin transfer molding or vacuum infusion process, autoclave process, press process.

Preferably, the composite according to the present invention is manufactured with a process comprising the steps of:
a) providing at least one hybrid fabric according to the present invention, wherein the hybrid fabric comprises a high-performance polyethylene (HPPE) fiber preferably arranged in a yarn, the fiber having a tensile modulus of at least 110 GPa, preferably of at least 120 GPa, more preferably of at least 130 GPa and most preferably of at least 135 GPa, and yet most preferably higher than 135 GPa, as measured according to ASTM D885M-2014; and non-polymeric fiber, preferably arranged in a yarn, wherein the cross-sectional area of the HPPE fiber, preferably of the HPPE yarn, is equal to or smaller than the cross-sectional area of the non-polymeric fiber, preferably of the non-polymeric yarn, with the cross-sectional area of the fiber, preferably of the yarn, being the linear density of the fiber, preferably of the yarn, divided by volumetric density of the fiber;
b) optionally assembling at least two of the fabrics provided in step a) form a stack;
c) applying a matrix material to the at least one hybrid fabric provided in step a) or applying a matrix material to the stack of step b), to obtain the composite.

The composite preferably has an upper surface and a lower surface, which is opposite to the upper surface. The term ‘adjacent layers’ means herein that the surface area of the layers (or inter alia one layer of fabric refers herein to one fabric) are adjacent, i.e. the surface of each layer is superimposed on or stacked onto or in direct contact with the surface of another layer(s). Preferably the stacking of the fabrics is carried out such that said fabrics overlap substantially over their entire surface, e.g. over more than 80% of their surface.

The stack comprising at least one hybrid fabric according to the present invention may be formed by compressing the fabrics assembly at a pressure of between 0 and 50 bar, preferably at least 1 bar and at most 3 bar. Typically, a curing process may start at this step or at mixing the matrix step, e.g. mixing the resin with a curing agent. Any conventional pressing means may be utilized in the process of the invention e.g. autoclave, mold, e.g. matched die process.

The compressing in step c) and/or curing process and/or the post-curing process, in case carried out depending on the matrix system, and/or impregnation may take place starting at room temperature (e.g. 20° C.) until below the melting temperature of the HPPE fiber, as measured by DSC (step c). For high strength polyethylene fibers, said temperature is between room temperature and 100° C. below Tm as a starting temperature and 2° C. below Tm as a final temperature. Higher temperatures may degrade the polymer fibers. The room temperature or a temperature of preferably between 50° C. and 150° C., more preferably between 80° C. and 145° C. may be chosen. Alternatively, a stack of at least one fabric containing a matrix material, preferably a resin may be supplied to a preheated press, being heated to a temperature as defined above.

The matrix is typically applied to the stack or to the individual hybrid fabrics in the stack of step c) by impregnation using any method known in the art, e.g. by dipping the stack or the individual fabrics in a resin bath. The matrix is preferably a resin in fluid form. In case the resin is a thermoplastic resin, impregnation takes place at a temperature below the melting temperature of the HPPE. After application of the resin, the resin is typically solidified. Before impregnation, the individual fabrics or the stack may be put in a vacuum bag to release the air from the stack or individual fabrics. The matrix preferably has a modulus in the hardened (solidified) state of between 1.5 and 8.0 GPa. The upper modulus values of this range side may be obtained by special resins like melamine-formaldehyde resins as matrix material. The lower modulus values are obtained when toughened resins are used as matrix material. Such toughening is not necessary for the present composites, because the fiber hybridization provides all toughening needed. Preferably, the modulus of the matrix material, e.g. solidified resin is between 2.0 and 5.0 GPa and most preferably between 3.0 and 4.0 GPa, the modulus being measured according to the method in the Examples section herein.

After forming, the composite may be cooled at room temperature, after which the pressure may be released.

The present invention also relates to an article comprising the hybrid fabric or the composite according to the present invention. Said article shows an improved combination of properties and balance between structural strength, stiffness and impact strength at same areal density with the composites known in the prior art. Furthermore, the present invention directs to the use of the hybrid fabric or of the composite according to the present invention in various application fields, such as automotive (e.g. wheel rims for cars and motorcycles, parts of the structural car chassis, bumper beams, interiors for cars, impact panels), aerospace (e.g. aircrafts, satellites), sports equipment (e.g. bicycles frames, cockpits, seats, hockey sticks, tennis and squash rackets, ski and snowboards, surfboards, paddle boards, helmets such as for cycling, football, climbing, motorsport), marine (e.g. boat hulls, masts, sails, boats), military, wind and renewable energy (e.g. wind turbines, tidal turbines). Also various pieces of equipment, like suitcases and containers can be made. When the hybrid fabric or composite according to the present invention is used in various applications, these applications show an improved combination properties and balance between structural strength, stiffness and impact strength, at the same areal density (weight) compared to the composites known in the prior art, allowing use of more layers in a composite for the same areal density.

The invention will be elucidated below with the aid of a number of examples without being limited thereto.

### EXAMPLES

### Methods

Tex: yarn's or filament's titer was measured by weighing 100 meters of yarn or filament, respectively. The tex of the yarn or filament was calculated by dividing the weight (expressed in milligrams) by 100.
IV: the Intrinsic Viscosity is determined according to method ASTM D1601 (2004) at 135° C. in decalin, the dissolution time being 16 hours, with BHT (Butylated Hydroxy Toluene) as anti-oxidant in an amount of 2 g/I solution, by extrapolating the viscosity as measured at different concentrations to zero concentration.
Tensile properties of HPPE fibers: tensile strength (or strength) and tensile modulus (or modulus) are defined and determined on multifilament yarns as specified in ASTM D885M (2014), using a nominal gauge length of the fiber of 500 mm, a crosshead speed of 50%/min and Instron 2714 clamps, of type “Fiber Grip D5618C”. On the basis of the measured stress-strain curve the modulus is determined as the gradient between 0.3 and 1% strain. For calculation of the modulus and strength, the tensile forces measured are divided by the titre, as determined above; values in GPa are calculated assuming a density of 0.975 g/cm³ for the HPPE.
Tensile properties of fibers having a tape-like shape: tensile strength, tensile modulus and elongation at break are defined and determined at 25° C. on tapes of a width of 2 mm as specified in ASTM D882, using a nominal gauge length of the tape of 440 mm, a crosshead speed of 50 mm/min.
Tensile modulus and tensile strength of the multilayer hybrid composite samples was measured according to standard method ISO 527/4 (2012) at room temperature, i.e. 25° C. Specimens with a width of 10±0.05 mm were machined from the panel in the warp direction of the fabrics. The thickness of the samples was measured at various places on the sample. Tabs of the same panel were glued to the ends to prevent clamp failure, using a high peel strength epoxy resin commercially available as Redux® 810 from Hexcel. Curing was done at room temperature. The gauge length of the samples was 25 mm. Test speed was 2 mm/min. Strains were measured with strain gauges. Tensile properties were measured on composite samples containing 6 layers of fabric. The tensile properties were scaled back to a normalized fiber volume fraction of 50%, by multiplying the measured value by the ratio of real fiber volume fraction and the normalized fiber volume fraction (e.g. Scaled modulus=measured modulus x real fiber volume fraction/normalized fiber volume fraction). In this scaling the contribution of the matrix is ignored.
Volumetric density of the multilayer hybrid composite samples was measured in water according to standard method ISO 1183-1 2012.
Areal Density (AD) of the fabrics was obtained by weighing a certain area of a sample and dividing the obtained mass by the area of the sample (kg/m²) and AD of the multilayer hybrid composite samples by multiplying the volumetric density of the composite by the thickness of the multilayer composite.
Impact strength (Fmax, puncture resistance and Energy to Fmax) of the multilayer hybrid composite samples were measured according to standard method ISO 6603-2 (2000) at room temperature, i.e. about 23° C. on a 10×10 cm² rectangular multilayer hybrid composite panel of thickness t, clamped using a ring with diameter 40 mm. Below the panel was placed an airgap. A hemispherical dart with 20 mm radius and mass m=23.67 kg was used to test the penetration resistance by varying the initial height h=1 m. Each plate was tested by 3 impacts with varying initial height h to generate penetrations and stops. Impact properties were measured on composite samples containing 6 layers of fabric.

### Fabric A (Comparative)

A plain single layer woven fabric A was produced from warp yarns and weft yarns in a 2/2 twill arrangement and 6.0 threads per cm of 100 vol % carbon fibers, based on the total fabric A composition, the carbon fibers being commercially available under the tradename Toray T300-3K from Toray, the fibers (or the yarn) having a linear density of 2000 dtex. AD of the fabric A was 245 g/m².

### Fabric B

A plain single hybrid woven fabric was produced from warp yarns and weft yarns in a 2/2 twill arrangement and 6.0 threads per cm. The fabric consists of 28 vol % UHMWPE fiber commercially available as Dyneema® SK99 (that is a yarn having a linear density of 880 dtex, a tenacity of 4.3 N/tex and a tensile modulus of 155 GPa, a volumetric density of the yarn or fiber of 975 kg/m′, such that cross-sectional area of the yarn was 0.09 mm²) and 72 vol % carbon fibers commercially available as Toray T300-3K (that is a yarn having a linear density of 2000 dtex, a tensile modulus of 230 GPa, a volumetric density of the yarn or fiber of 1760 kg/m′, such that cross-sectional area of the yarnwas 0.113 mm²), the vol % being based on the total fabric B composition. The weft and the warp yarns comprise Dyneema® SK99 fibers and carbon fibers in a yarn ratio of 1:2 in the woven fabric B. AD of the fabric B was 192 g/m².

### Fabric C (Comparative)

A plain single hybrid woven fabric was produced from warp yarns and weft yarns in a 2/2 twill arrangement and 6.7 threads per cm. The fabric consists of 45 vol % UHMWPE fiber commercially available as Dyneema® SK75 (that is a yarn having a linear density of 1760 dtex, a tenacity of 3.5 N/tex and a tensile modulus of 135 GPa, a volumetric density of the yarn or fiber of 975 kg/m³, such that the cross-sectional area of the yarn was 0.18 mm²) and 55 vol % carbon fibers commercially available as Pyrofil TR30S-3K (that is a yarn having a linear density of 2000 dtex, a tensile modulus of 235 GPa, a volumetric density of the yarn of fiber of 1790 kg/m³, such that cross-sectional area of the yarn was 0.11 mm²), the vol % being based on the total fabric C composition. The weft and the warp yarns comprise Dyneema® SK75 fibers and carbon fibers in a yarn ratio of 1:2 in the woven fabric C. AD of the fabric C was 250 g/m².

### Fabric D (Comparative)

A plain single hybrid woven fabric was produced from warp yarns and weft yarns in a 2/2 twill arrangement and 6.0 threads per cm. The fabric consists of 28 vol % UHMWPE fiber commercially available as Dyneema® SK99 (that is a yarn having a linear density of 1760 dtex, a tenacity of 4.3 N/tex and a tensile modulus of 155 GPa, a volumetric density of the yarn or fiber of 975 kg/m³, such that cross-sectional area of the yarn was 0.18 mm²) and 72 vol % carbon fibers commercially available as Toray T300-3K (that is a yarn having a linear density of 2000 dtex, a tensile modulus of 230 GPa, a volumetric density of the yarn or fiber of 1760 kg/m′, such that cross-sectional area of the yarn was 0.113 mm²), the vol % being based on the total fabric D composition. The weft and the warp yarns comprise Dyneema® SK99 fibers and carbon fibers in a yarn ratio of 1:4 in the woven fabric D. AD of the fabric D was around 235 g/m².

### Fabric E (Example)

A plain single hybrid woven fabric was produced from warp yarns and weft yarns in a 2/2 twill arrangement and 6.0 threads per cm. The fabric consists of 28 vol % UHMWPE fiber commercially available as Dyneema® SK75 (that is a yarn having a linear density of 880 dtex, a tenacity of 3.5 N/tex and a tensile modulus of 135 GPa, a volumetric density of the yarn or fiber of 975 kg/m′, such that cross-sectional area of the yarn was 0.09 mm²) and 72 vol % carbon fibers commercially available as Toray T300-3K (that is a yarn having a linear density of 2000 dtex, a tensile modulus of 230 GPa, a volumetric density of the yarn or fiber of 1760 kg/m³, such that cross-sectional area of the yarn was 0.113 mm²), the vol % being based on the total fabric E composition. The weft and the warp yarns comprise Dyneema® SK75 fibers and carbon fibers in a yarn ratio of 1:2 in the woven fabric E. AD of the fabric E was 192 g/m².

The fabrics A-E obtained as shown herein above were then each cut on size and stacked in different multilayer hybrid constructions as shown in the Examples and Comparative Examples herein below. All layers in the stack were aligned along warp and weft direction. Each stack of layers was put in a vacuum plastic bag that had an inlet and an outlet, in order to remove all the air from the stack and then placed on an infusion table for subsequent impregnation with a resin. A flow medium (commercially available as Compoflex RF150 purchased from Fibertex that is a fabric based on polypropylene that helps the resin flowing through the stack) was added to the vacuum bag, as well as spiral tubes for both inlet and outlet of the vacuum bag were placed to seal the infusion table. The infusion table was then left for 30 min at room temperature to degas under vacuum and to remove the moisture from the fabrics.

A mixture of an epoxy resin that is known under the commercial name EPIKOTE resin 04908/1 with EPIKURE Curing Agent 04908 commercially available from Hexion was employed as the resin matrix. Before infusion, the resin was degassed in a vacuum chamber to remove all air. The impregnation process of the stack of layers with the resin took place at a temperature of 40° C. and an absolute pressure of 0.01 bar (vacuum). After full saturation of the fabrics (meaning that each layer of the stack was impregnated with the resin in such a way that the stack contained no voids), the inlet of the bag was closed and the infusion table was heated to a temperature of 70° C. Then, polyurethane plates were placed on top of the table to cover the stack. The multilayer hybrid composites so formed were left to cure for 16 hours at a temperature of 70° C.

### Example 1

A multilayer hybrid composite was formed by stacking layers comprising fabrics B and then impregnating the stack obtained as described herein above and then forming a multilayer hybrid composite. The composition of the multilayer hybrid composite obtained was 54 vol % resin, 46 vol % of total volume of fabric B, 13 vol % UHMWPE fibers and 33 vol % carbon fibers, each based on the total volume of the multilayer hybrid composite. The results are reported in Table 1.

### Comparative Experiment 1 (CE1)

A multilayer hybrid composite was formed by stacking layers comprising fabric A and then impregnating the stack obtained as described herein above and then forming a multilayer hybrid composite. The composition of the multilayer hybrid composite obtained was 50 vol % carbon fibers and 50 vol % resin, each based on the total volume of the multilayer hybrid composite. The results are reported in Table 1.

### Comparative Experiment 2 (CE2)

A multilayer hybrid composite was formed by stacking layers comprising fabric C and then impregnating the stack obtained as described herein above and then forming a multilayer hybrid composite. The composition of the multilayer hybrid composite obtained was 45 vol % resin, 55 vol % of total volume of fabric C, 24.8 vol % UHMWPE fibers and 30.7 vol % carbon fibers, each based on the total volume of the multilayer hybrid composite. The results are reported in Table 1.

### Comparative Experiment 3 (CE3)

A multilayer hybrid composite was formed by stacking layers comprising fabric D and then impregnating the stack obtained as described herein above and then forming a multilayer hybrid composite. The composition of the multilayer hybrid composite obtained was 50 vol % resin, 50 vol % of total volume of fabric B, 14 vol % UHMWPE fibers and 36 vol % carbon fibers, each based on the total volume of the multilayer hybrid composite. The results are reported in Table 1.

### Example 2 (Ex. 2)

A multilayer hybrid composite was formed by stacking layers comprising fabric E and then impregnating the stack obtained as described herein above and then forming a multilayer hybrid composite. The composition of the multilayer hybrid composite obtained was 48 vol % resin, 52 vol % of total volume of fabric B, 14.5 vol % UHMWPE fibers and 38.5 vol % carbon fibers, each based on the total volume of the multilayer hybrid composite. The results are reported in Table 1.

TABLE 1

| Sample | CE1 | CE2 | CE3 | Ex. 2 | Ex. 1 |
|---|---|---|---|---|---|
| Length sample, mm | 600 | 600 | 400 | 400 | 500 |
| Width sample, mm | 500 | 500 | 400 | 400 | 500 |
| Composite panel thickness | 1.67 | 2.09 | 1.86 | 1.45 | 1.69 |
| 6 layers, mm | | | | | |
| Composite AD for 6 layer | 2450 | 2715 | 2500 | 1980 | 2264 |
| panel, g/m² | | | | | |
| Composite volumetric | 1.47 | 1.31 | 1.34 | 1.36 | 1.34 |
| density, g/cm³ | | | | | |
| Fiber volume fraction, % | 50 | 55 | 50 | 52 | 46 |
| UHMWPE fiber in total | 0 | 24.8 | 14 | 14.5 | 13 |
| composite composition, vol % | | | | | |
| Tensile modulus, GPa | 57.1 | 40.7 | 39.8 | 42.2 | 46 |
| Tensile strength, MPa | 878 | 447 | 453 | 475 | 518 |
| Scaled Tensile Modulus | 57.1 | 37.0 | 39.8 | 40.6 | 50.0 |
| to 50% Fiber Vol, GPa | | | | | |
| Scaled Tensile Strength | 878 | 406 | 453 | 457 | 563 |
| to 50% Fiber Vol, MPa | | | | | |
| Fmax upon impact, N | 2054 | 2387 | 4650 | 3158 | 2743 |
| Energy to Fmax, J | 5.69 | 4.95 | 9.67 | 4.86 | 6.41 |
| Puncture energy, J | 9.87 | 11.4 | 18.04 | 13.56 | 17.25 |
| Fmax/AD | 0.84 | 0.88 | 1.86 | 1.59 | 1.21 |
| Energy to Fmax/AD | 0.0023 | 0.0018 | 0.0039 | 0.0025 | 0.0028 |
| Puncture energy/AD | 0.0040 | 0.0042 | 0.0072 | 0.0068 | 0.0076 |

The results presented in Table 1 show that the multilayer hybrid composites obtained with the hybrid fabric according to the present invention (Example 1 and Example 2) show the best balance of good structural stiffness, strength and good impact performance. On the other hand, the Comparative Examples show poor impact strength (Comparative Example 1) and low structural properties (tensile strength, and tensile modulus of Comparative Examples 2 and 3).

1. A hybrid fabric comprising:
i) a high-performance polyethylene (HPPE) fiber arranged in a yarn having a tensile modulus of at least 110 GPa, as measured according to ASTM D885M-2014; and
ii) a non-polymeric fiber arranged in a yarn,
wherein the cross-sectional area of the HPPE yarn is equal to or smaller than the cross-sectional area of the non-polymeric yarn, the cross-sectional area being defined as the linear density of the yarn divided by volumetric density of the fiber.

2. The hybrid fabric according to claim 1, wherein the high-performance polyethylene (HPPE) fiber has a tensile modulus of at least 120 GPa, preferably of at least 130 GPa, more preferably of higher than 135 GPa.

3. The hybrid fabric according to claim 1, wherein the high-performance polyethylene (HPPE) fiber has a tensile modulus of at least 140 GPa, preferably of at least 145 GPa, more preferably of at least 150 GPa, most preferably of at least 155 GPa.

4. The hybrid fabric according to claim 1, wherein the non-polymeric fibers are selected from a group consisting of carbon fibers, glass fibers, wollastonite fibers, basalt fibers and/or mixtures thereof.

5. The hybrid fabric according to claim 1, wherein the fabric is knitted, plaited, braided or a combination thereof, preferably the fabric is a woven fabric.

6. The hybrid fabric according to claim 1, wherein the HPPE fiber is prepared by a melt spinning process, a gel spinning process or solid-state powder compaction process.

7. The hybrid fabric according to claim 1, wherein the HPPE fiber has a tenacity of at least 2 N/tex, preferably of at least 3 N/tex, more preferably at least 3.5 N/tex, as measured at yarn level.

8. The hybrid fabric according to claim 1, wherein the HPPE fiber comprises ultra-high molecular weight polyethylene (UHMWPE), preferably the HPPE fibers are UHMWPE fibers.

9. The hybrid fabric according to claim 1, further comprising a matrix material.

10. The hybrid fabric according to claim 1 comprising of from 15 to 45 vol %, preferably from 15 to 35 vol % HPPE fiber relative to the total volume of the matrix free hybrid fabric.

11. A composite comprising at least one layer of the hybrid fabric according to claim 1.

12. The composite according to claim 11, further comprising at least one layer of other fabric comprising of from 100 to 80 vol % non-polymeric fibers and from 0 to 20 vol % HPPE fibers, based on the total volume of the other fabric.

13. An article comprising the composite according to claim 11, the article being selected from wheel rim for cars, bicycles and motorcycles, interiors for cars, impact panels, aircrafts, satellites, bicycles frames, cockpits, seats, hockey sticks, baseball bats, tennis and squash rackets, ski and snowboards, surfboards, paddle boards, helmets such as for cycling, football, climbing, motorsport, boat hulls, masts, sails, boats, wind turbines and tidal turbines.

14. Use of the article according to claim 13 in automotive field, preferably in wheel rims for cars and motorcycles, interiors for cars, impact panels; in aerospace field, preferably in aircrafts and satellites; in sports equipment, preferably in bicycles, bicycles frames, cockpits, seats, hockey sticks, baseball bats, tennis and squash rackets, ski and snowboards, surfboards, paddle boards, helmets such as for cycling, football, climbing, motorsport; in marine field, preferably in boat hulls, masts, sails, boats; in military field; and in wind and renewable energy field, preferably in wind turbines and tidal turbines.
